(19) United States
(12) Patent Application Publication
(10) Pub. No.: US 2012/0013709 A1
(43) Pub. Date: Jan. 19, 2012

(54) VIDEO SIGNAL PROCESSING DEVICE, VIDEO PROCESSING SYSTEM, SEMICONDUCTOR INTEGRATED CIRCUIT, AND VIDEO SIGNAL PROCESSING METHOD

(75) Inventor: Yuuki NISHIO, Kyoto (JP)

(73) Assignee: Panasonic Corporation, Osaka (JP)

(21) Appl. No.: 13/242,774

(22) Filed: Sep. 23, 2011

Related U.S. Application Data
(63) Continuation of application No. PCT/JP2009/005928, filed on Nov. 6, 2009.

(30) Foreign Application Priority Data
Jun. 30, 2009 (JP) 2009-155104

(51) Int. Cl. H04N 13/00

(52) U.S. Cl. 348/43; 348/E13.064

(57) ABSTRACT

In a video signal processing circuit, when a 2D video signal is transferred in a 3D transfer format from a video signal source, a one side mute control section provided in an input video control section determines whether the 2D video signal is on the L side or on the R side of the 3D transfer format. During a period of the one side (e.g., the L side) that is not used by the 2D video signal, the one side mute control section replaces data loaded on the one side in the video signal source with fixed data, and sends it through an input video control section, a color space changing section and a packet loading section in this order. This stops these three circuit sections from operating unnecessarily, thereby reducing the power consumption.

### CROSS-REFERENCE TO RELATED APPLICATION

This is a continuation of PCT International Application PCT/JP2009/005928 filed on Nov. 6, 2009, which claims priority to Japanese Patent Application No. 2009-155104 filed on Jun. 30, 2009. The disclosures of these applications including the specifications, the drawings, and the claims are hereby incorporated by reference in its entirety.

### BACKGROUND

The present invention primarily relates to an HDMI transmission circuit and a system thereof, using the HDMI standard which is a digital video/audio transfer transmission standard.

Currently, under the HDMI (High Definition Multimedia Interface) standard, which is a standard for transferring high-vision video in non-compressed digital data, a standard relating to the transfer of a stereoscopic video signal (hereinafter referred to as a “3D video signal”) is being made. This HDMI standard is described in, for example, NON-PATENT DOCUMENT 1.

The 3D video signal is transferred from a video reproduction device for a blu-ray disc, a DVD, etc., storing the 3D video signal therein to a display device such as a TV, in the HDMI standard compatible with 3D video signals. In broadcasting, while the programs are transferred in a 3D video signal, CMs (commercial messages) are normally transferred in a video signal (hereinafter referred to as a “2D video signal”). Therefore, there is a need to dynamically switch between 3D transfer and 2D transfer.

### CITATION LIST

### Non-Patent Document

NON-PATENT DOCUMENT 1: High Definition Multimedia Interface Specification Version 1.4 page 143-145 and 188-193, published by HDMI Licensing, LLC

### SUMMARY

However, the conventional technique has problems as follows. That is, as shown in FIGS. 17A and 17B, when dynamically switching between 3D transfer and 2D transfer, a vertical sync signal (hereinafter referred to as “Vsync”) 100 for the 2D video signal shown in FIG. 17A and a Vsync 101 for the 3D video signal shown in FIG. 17B are different from each other in terms of the input video clock and the shape of Vsync. Therefore, the authentication sequence of the HDMI standard needs to be re-done each time. However, if the authentication sequence is re-done each time, the display screen will be blacked out for several seconds during the authentication, and therefore the technique is not suitable for dynamic switching.

Therefore, as shown in FIGS. 18A and 18B, for example, when a 3D video signal is transferred in a 3D transfer format shown in FIG. 18A, left-eye data (hereinafter referred to as “L data”) 200 and right-eye data (hereinafter referred to as “R data”) 201 are sent alternately with each other as is normally the case, whereas when a 2D video signal 210 is transferred in the 3D transfer format while being loaded only on one side (the L side in the figure) as shown in FIG. 18B, there is no video transfer format switching, and it is not necessary to re-do the authentication sequence. Therefore, it is believed that the instantaneous switching is possible.

When transferring a 2D video signal in the 3D transfer format as described above, in a video reproduction device for a blu-ray disc, a DVD, etc., from which the 2D video signal is transferred, the 2D video signal 210 which is valid data is loaded only on one side and predetermined data (invalid data) 211 is arbitrarily loaded on the remaining side (the R side in the figure) as shown in FIG. 18B. For the invalid data 211 on the R side which is not used by the 2D video signal, the data to be transferred from the video reproduction device for a blu-ray disc, a DVD, etc., is unknown. Therefore, where the invalid data is random data, video data-related circuits operate unnecessarily, thereby increasing the power consumption.

FIG. 19 shows an example of a conventional HDMI transmission-side transfer system. Note that while the configuration is assumed to be that of a video-transmitting system such as a blu-ray or DVD player or recorder or a digital video camera, the present invention is not limited thereto.

In FIG. 19, an HDMI transmission-side transfer system 302 includes an input video control section 310 for receiving a Video signal transferred from a video signal source 301 and performing data shaping, generation of a data valid enable signal, etc., for the received Video signal, a color space changing section 311 for changing the color space of the input Video data, a packet loading section 312 for loading Audio data or control packets in the blank periods of the Video signal, and an encoding section 313 for performing 8 bit-10 bit conversion for differential transfer so as to maintain the DC balance. The received Video signal passes through the circuit sections described above, and is sent to the HDMI receiver side to be displayed on a display device 304. Note that a host CPU 303 controls a register control section 314.

Where the video signal source 301 transfers a 2D video signal in a 3D transfer format, the data to be loaded by the video signal source 301 on the unused side, either the L side or the R side, of the 3D transfer format is unknown. Therefore, if random data is transferred on the unused side to the HDMI transmission-side transfer system 302, the video data-related circuits operate in various circuit sections of the input video control section 310, the color space changing section 311 and the packet loading section 312, thereby unnecessarily consuming power.

It is therefore an object of the present invention to reduce the power consumption by preventing video data-related circuits from operating unnecessarily for invalid data on one side that is unused in cases where a 2D video signal is transferred in a 3D transfer format.

In order to achieve the object set forth above, where a 2D video signal is transferred in a 3D transfer format, a video signal processing device of the present invention determines the period of the L side or the R side of the 3D transfer format so that, based on the determination result, the invalid data on one side that is unused is converted to fixed data or the clock signal supplied to video data-related circuits, which would otherwise be operating unnecessarily, is stopped during the period of the one side that is unused.

Specifically, a video signal processing device of the present invention is a video signal processing device for processing a 3D video signal, including: a signal processing section for receiving the 3D video signal and performing a predetermined signal process; and a one side mute control section, wherein when a 2D video signal is transmitted in a 3D video transfer format where left-eye data is loaded on an L side and right-eye data is loaded on an R side with the 2D video signal using one of the two sides, the one side mute control section determines whether the 2D video signal is on the L side or on the R side so as to stop an operation of the signal processing section during a period of the one side that is not used by the 2D video signal.

In one embodiment of the present invention, the signal processing section performs a predetermined signal process on a video signal received in an HDMI standard.

In one embodiment of the present invention, the one side mute control section stops the operation of the signal processing section by outputting fixed data to the signal processing section during the period of the one side that is not used by the 2D video signal.

In one embodiment of the present invention, the one side mute control section stops the operation of the signal processing section by stopping supply of a clock signal to the signal processing section during the period of the one side that is not used by the 2D video signal.

In one embodiment of the present invention, the one side mute control section stops the operation of the signal processing section by stopping supply of a clock signal to the signal processing section while outputting fixed data to the signal processing section during a period of the one side that is not used by the 2D video signal.

In one embodiment of the present invention, the one side mute control section receives a color space specifying signal of the input 2D video signal and outputs black color data corresponding to the color space specifying signal to the signal processing section as the fixed data.

In one embodiment of the present invention, the one side mute control section receives the fixed data from a host CPU and outputs the received fixed data to the signal processing section.

In one embodiment of the present invention, the one side mute control section has two functions including: a function of receiving a color space specifying signal of the input 2D video signal and outputting black color data corresponding to the color space specifying signal to the signal processing section as the fixed data; and a function of receiving the fixed data from a host CPU and outputting the received fixed data to the signal processing section.

In one embodiment of the present invention, a plurality of signal processing sections are provided each for performing a predetermined signal process, the one side mute control section receives from outside a selection signal for selecting one of the plurality of signal processing sections, and stops supply of a clock signal to one of the signal processing sections selected by the selection signal during a period of the one side that is not used by the 2D video signal.

In one embodiment of the present invention, the one side mute control section receives an operation mode setting signal and determines based on the received mode setting signal whether supply of a clock signal is stopped during a period of the one side that is not used by the 2D video signal or the supply of the clock signal is stopped also on the side that is used.

In one embodiment of the present invention, the 3D transfer format is set from outside to the one side mute control section, and the determination between the L side and the R side is made in accordance with the set 3D transfer format.

In one embodiment of the present invention, the one side mute control section receives from outside an identification signal indicating an identification of the L side and the R side of the 3D transfer format, and the determination between the L side and the R side is made based on the received identification signal.

In one embodiment of the present invention, the one side mute control section receives from a host CPU a switching signal indicating whether the L side or the R side, for which the determination has been made, is regarded as one side that is not used by the 2D video signal, and stops the operation of the signal processing section during a period of the one side that is not used by the 2D video signal based on the received switching signal.

In one embodiment of the present invention, a 2D/3D setting signal indicating whether a currently-input video signal is a 2D video signal or a 3D video signal is received from a host CPU, and the operation of the signal processing section is stopped during a period of the one side that is not used by the 2D video signal based on the received 2D/3D setting signal.

In one embodiment of the present invention, a 2D/3D setting signal indicating whether a currently-input video signal is a 2D video signal or a 3D video signal is received from outside, and the operation of the signal processing section is stopped during a period of the one side that is not used by the 2D video signal based on the received 2D/3D setting signal.

In one embodiment of the present invention, 2D/3D setting signals each indicating whether a currently-input video signal is a 2D video signal or a 3D video signal are received from a host CPU and from outside, and the operation of the signal processing section is stopped during a period of the one side that is not used by the 2D video signal based on the received 2D/3D setting signals.

A video processing system of the present invention includes the video signal processing device set forth above.

A semiconductor integrated circuit of the present invention includes the video signal processing device set forth above.

In one embodiment of the present invention, the signal processing section includes a process circuit section for performing a predetermined process on a video signal, and a packet loading section.

In one embodiment of the present invention, the process circuit section includes an input video control section, and a color space changing section.

A video signal processing method of the present invention is a video signal processing method for processing a 3D video signal, including: receiving a 2D video signal transmitted in a 3D video transfer format where left-eye data is loaded on an L side and right-eye data is loaded on an R side with the 2D video signal using one of the two sides, then determining whether the received 2D video signal is on the L side or on the R side, and stopping an operation of a signal processing section, which is for receiving the 3D video signal and performing a predetermined signal process, during a period of the one side that is not used by the 2D video signal based on the determination result.

With the video signal processing device and method of the present invention having such a configuration as described above, when a 2D video signal is transferred in a 3D transfer format, it is determined whether the L side or the R side of the 3D transfer format is the unused side so that the video data on the unused side is changed to the fixed data or the supply of the clock signal to the signal processing circuit is stopped only for the unused side, thereby allowing for a reduction in the power consumption of these signal processing circuits while transferring the signal on the unused side.

As described above, with the video signal processing device and method of the present invention, even when a 2D video signal is transferred in a 3D transfer format, it is possible to prevent the signal processing circuits from operating unnecessarily, thus allowing for a reduction in the power consumption of these signal processing circuits.

### BRIEF DESCRIPTION OF THE DRAWINGS

FIG. 1 is a diagram showing a general configuration of a video signal processing device according to a first embodiment of the present invention.

FIG. 2 is a diagram showing an internal configuration of a one side MUTE section control section provided in the video signal processing device.

FIG. 3A is a diagram showing an example of how an LR determination signal is generated by an LR determination circuit provided in the video signal processing device, and FIG. 3B is a diagram showing another example of how the LR determination signal is generated.

FIG. 4 is a diagram showing an example of how a one side mute control section operates.

FIG. 5 is a diagram showing a general configuration of a video signal processing device according to a second embodiment of the present invention.

FIG. 6 is a diagram showing a general configuration of a video signal processing device according to a third embodiment of the present invention.

FIG. 7 is a diagram showing a first variation of a one side MUTE section control section provided in the video signal processing device of the first to third embodiments of the present invention.

FIG. 8 is a diagram showing a second variation of the one side mute control section.

FIG. 9 is a diagram showing a third variation of the one side mute control section.

FIG. 10 is a diagram showing a first variation of a clock control section provided in the video signal processing device of the second and third embodiments of the present invention of the present invention.

FIG. 11 is a diagram showing a second variation of the clock control section.

FIG. 12 is a diagram showing a first variation of the LR determination circuit provided in the video signal processing device according to the first to third embodiments of the present invention.

FIG. 13 is a diagram showing a first variation of a fixed side output section provided in the video signal processing device according to the first to third embodiments of the present invention.

FIG. 14 is a diagram showing a second variation of the fixed side output section.

FIG. 15 is a diagram showing a third variation of the fixed side output section.

FIG. 16 is a diagram showing a fourth variation of the fixed side output section.

FIGS. 17A and 17B are diagrams showing an example of a 2D video transfer format and an example of a 3D video transfer format.

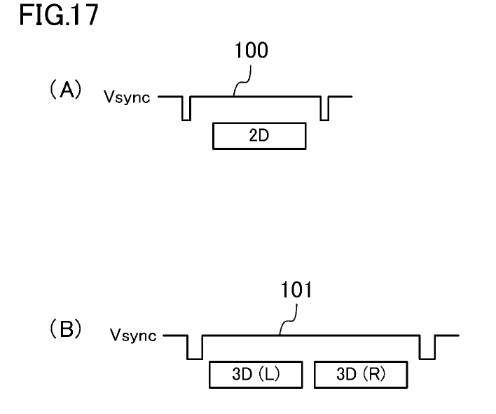

FIGS. 18A and 18B are diagrams showing an example where a 2D video is transferred using a 3D video transfer format.

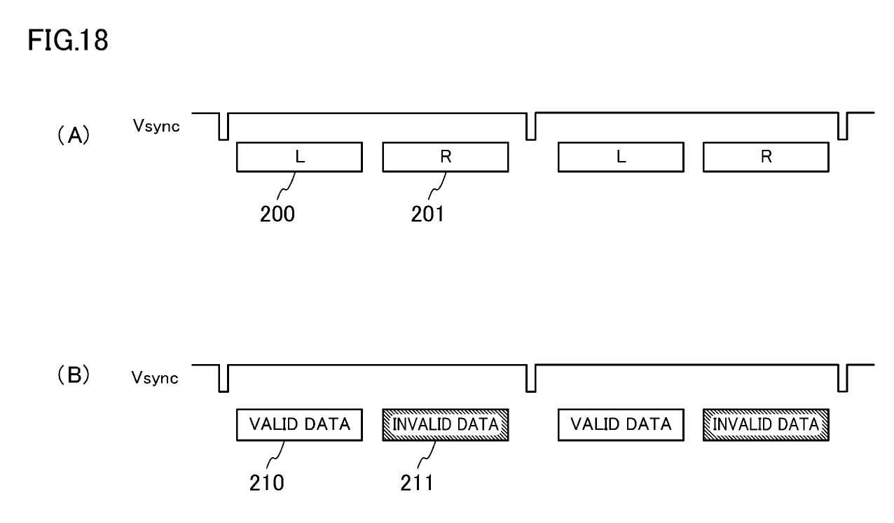

FIG. 19 is a diagram showing a configuration of a conventional video signal processing device.

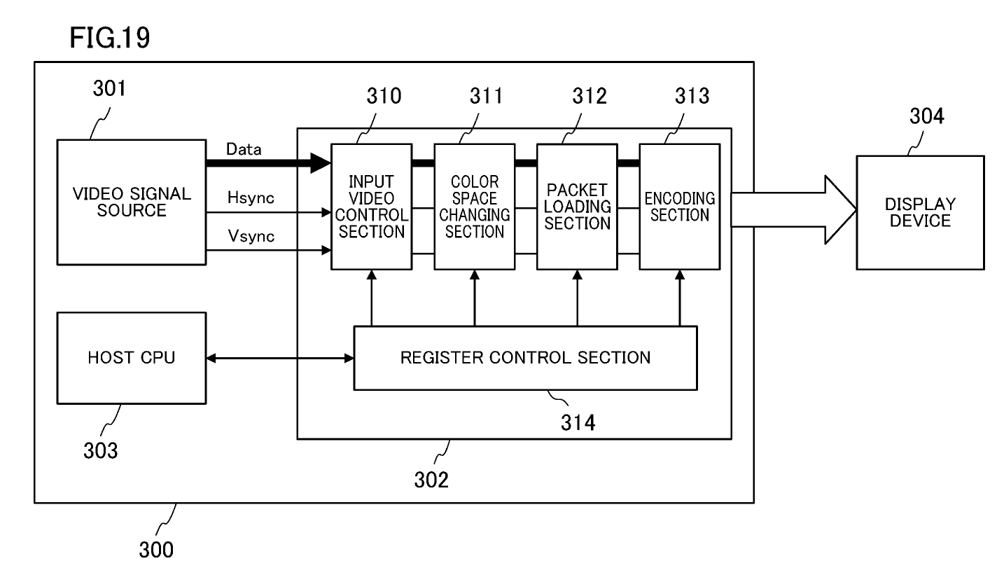

### DETAILED DESCRIPTION

Video signal processing devices according to embodiments of the present invention will now be described with reference to the drawings. Note that while the description of the present invention is directed to an HDMI transmission system, the present invention is not limited to HDMI.

### First Embodiment

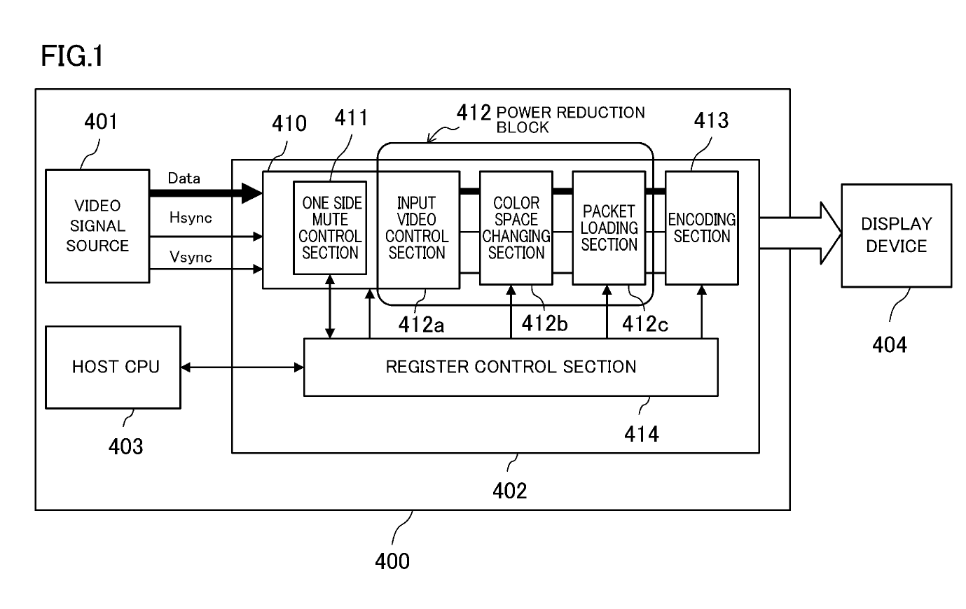

FIG. 1 shows a video signal processing device according to a first embodiment of the present invention.

FIG. 1 shows a video device 400 such as a blu-ray or DVD player or recorder, wherein video data is sent from a video signal source 401 to an HDMI transfer section 402, and the device as a whole is controlled by a host CPU 403. Therefore, the host CPU 403 knows whether the output video is a 3D output or a 2D output while the video signal source 401 is transferring a video signal in compliance with a 3D format.

A one side mute control section 411 is newly added inside an input video control section 410. Various settings such as the 3D transfer format are made in the one side mute control section 411 by the host CPU 403 through a register control section 414. A power reduction block 412 is provided subsequent to the one side mute control section 411 in the input video control section 410, and the power reduction block 412 includes an input video control section (process circuit section) 412a, a color space changing section (process circuit section) 412b and a packet loading section 412c. The input video control section 412a performs shaping of the received Video signal, generation of the data valid enable signal, etc. The color space changing section 412b changes the color space of the received Video signal, and the packet loading section 412c loads Audio data and control packets in the blank periods of the Video signal. Note that while the one side mute control section 411 is provided inside the input video control section 410 in the present embodiment, the configuration is not limited thereto, and it may be a different block from the input video control section 410, and the position where it is provided is also not limited to that of the present embodiment. Note however that the advantages of the present invention are more likely to be obtained if it is provided in an earlier stage of the HDMI transfer section 402.

An encoding section 413 is further provided inside the input video control section 410. The encoding section 413 performs 8 bit-10 bit conversion for differential transfer so as to maintain the DC balance between the differential lines.

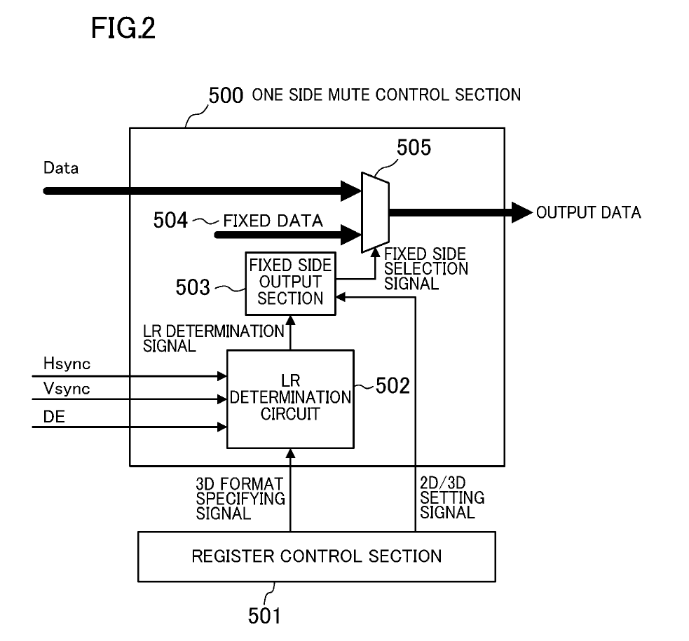

Next, an internal configuration of the one side mute control section 411 will be described with reference to FIG. 2. In a one side mute control section 500 shown in FIG. 2, an LR determination circuit 502 receives the 3D transfer format specifying signal from a register control section 501, the video control signal Vsync, the horizontal sync signal Hsync, and the data valid region signal DE of the 3D video signal, and makes the L side/R side region determination of the input 3D transfer format based on these information. Note that while the data valid region signal DE is input from the video signal source 401 to the one side mute control section 500 in FIG. 2, the data valid region signal DE is input to the LR determination circuit 502 from the inside of the HDMI transfer section 402 in a case where it is not transmitted from the video signal source 401 but is generated inside the HDMI transfer section 402.

Moreover, in the one side mute control section 500, the LR determination signal of the LR determination circuit 502 is input to a fixed side output section 503, and a fixed side selection signal is generated in the fixed side output section 503. For example, where the R side is fixed, the fixed side output section 503 outputs a fixed side selection signal that is 1 when the received LR determination signal indicates the R side. In a case where the L side is fixed, a fixed side selection signal is output that is 1 when the received LR determination signal indicates the L side. The fixed side output section 503 receives a 2D transfer or 3D transfer setting signal from the register control section 501. In the case of a 3D video signal transfer, 3D transfer setting is made to the register control section 501 from the host CPU 403, and the 3D setting signal is received from the register control section 501 so as to fix the fixed side selection signal to 0 so that data of either the L side or the R side is not fixed.

Moreover, in the one side mute control section 500 of FIG. 2, the fixed side selection signal of the fixed side output section 503 is input to a selector 505. Based on the fixed side selection signal, the selector 505 selects fixed data 504 when data on the unused side of a 2D video signal in a 3D transfer format is received (the fixed side selection signal=1), whereas when data on the used side of the 2D video signal is received (the fixed side selection signal=0), the data of the 2D video signal is selected and output.

Thus, the one side mute control section 500 replaces data on the unused side of the 2D video signal in a 3D transfer format with a fixed value and outputs the data to the subsequent power reduction block 412 which is a video data-related circuit, thereby stopping the operation thereof and reducing the power consumption.

Therefore, if the fixed data is fixed at 0 or 1, the state where data does not change or transition continues in the subsequent power reduction block 412 (the input video control section 412a, the color space changing section 412b and the packet loading section 412c), thus realizing a lower power consumption.

Note that the fixed data is not limited to 0, 1, etc., but may be black color data in accordance with the color space of the input video data, for example.

As described above, also when transferring a 2D video signal in a 3D transfer format, the power consumption of the power reduction block 412 can be reduced by determining the unused side of the 2D video signal in the 3D transfer format and fixing the data on the unused side.

In the region of the unused side of the 2D video signal in the 3D transfer format, a video signal in accordance with the fixed data 504 is input to the encoding section 413, encoded in accordance with the HDMI standard, and transferred to and displayed on a display device 404.

Note that the configuration of the present embodiment can be incorporated in different set devices such as DVD players or recorders, digital cameras, etc.

(Example of how LR Determination Circuit Operates)

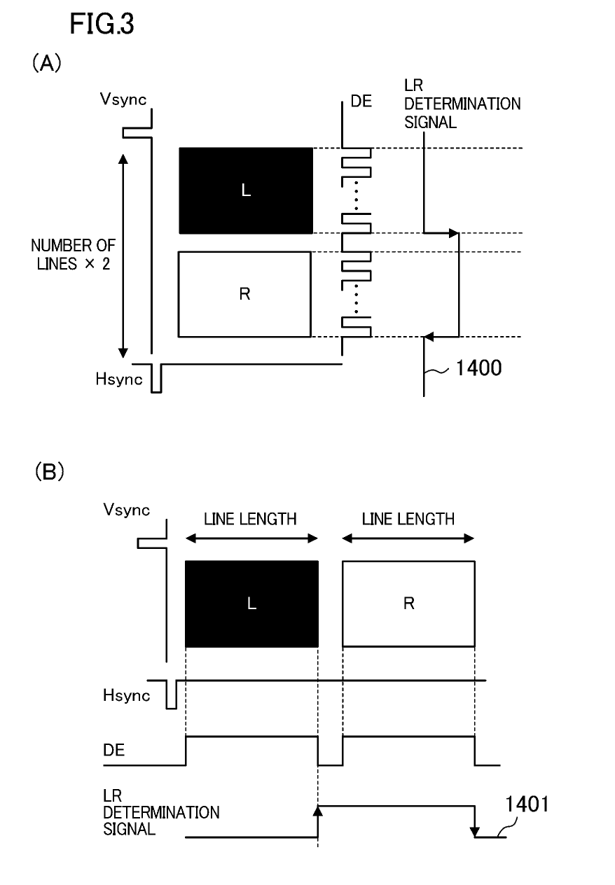

Next, a specific example of the operation of the LR determination circuit 502 in the one side mute control section 500 shown in FIG. 2 is shown in FIGS. 3A and 3B.

Referring to FIGS. 3A and 3B, if a 3D transfer format where the number of vertical lines is twice that of the screen is input, as shown in FIG. 3A, for example, the host CPU 403 notifies the LR determination circuit 502 of the content of the format. In response to this, the LR determination circuit 502 initializes an LR determination signal 1400 at the edge of input Vsync to first set it to 0 (determining it is the L side). Then, the number of edges of the data valid region signal DE of the video signal is counted, and when the count reaches a predetermined number of lines, the LR determination signal 1400 is reversed to 1 (determining it is the R side). Then, at the edge of input Vsync, or when the count of the number of edges of the data valid region signal DE reaches a predetermined number of lines, the LR determination signal 1400 is initialized again. In the LR determination circuit 502, the LR determination signal 1400 for the 3D transfer format of FIG. 3A is generated as described above.

On the other hand, if a 3D transfer format where the number of horizontal lines is twice that of the screen is input, as shown in FIG. 3B, the host CPU 403 notifies the LR determination circuit 502 of the content of the 3D transfer format. In response to this, the LR determination circuit 502 initializes an LR determination signal 1401 at the edge of input Vsync to first set it to 0 (determining it is the L side). Then, at the falling edge of the data valid region signal DE of the video signal, or when the count of the number of pixels reaches one line, the LR determination signal 1401 is reversed to 1 (determining it is the R side). Then, for example, at the next falling edge of the data valid region signal DE, the LR determination signal 1401 is initialized again. In the LR determination circuit 502, the LR determination signal 1401 for the 3D transfer format of FIG. 3B is generated as described above.

The LR determination signals 1400 and 1401 precisely detecting the L side and the R side of the 3D transfer format are generated in the above description. However, for the purpose of replacing data on the unused side (e.g., the R side) of the 2D video signal transferred in the 3D transfer format from the video signal source 401 with the fixed data 504, the LR determination signals 1400 and 1401 may be set to 1 (determining it is the R side) in the middle of the region of the L side, for example.

While two examples of FIGS. 3A and 3B are described in the present embodiment, the 3D transfer format is not limited to the two examples.

The reduction in the power consumption in the power reduction block 412 obtained by fixing data on the unused side of the 2D video signal in the 3D transfer format will be described. In the case of a 3D video signal, the input video control section 412a and the color space changing section 412b in the power reduction block 412 operate only in the H period of the data valid region signal DE shown in FIGS. 3A and 3B, and stop operating in the L period of the data valid region signal DE, i.e., the blanking period where the video data is absent. On the other hand, the packet loading section 412c operates in the H period of the data valid region signal DE, and also operates in a part of the L period of the data valid region signal DE for loading Audio data or control packets. On the other hand, the encoding section 413 operates at all times. With a 2D video signal using a 3D video format, for data (invalid data) on one of the L side and the R side of the 3D transfer format, the power reduction block 412, i.e., the input video control section 412a, the color space changing section 412b and the packet loading section 412c (the three signal processing sections) operates, but since the invalid data is not essentially part of the 2D video signal, the invalid data on the one side is replaced with the fixed data 504 in the one side mute control section 500. Therefore, these circuit sections stop operating in the period of the one side of the invalid data, thus reducing the power consumption accordingly.

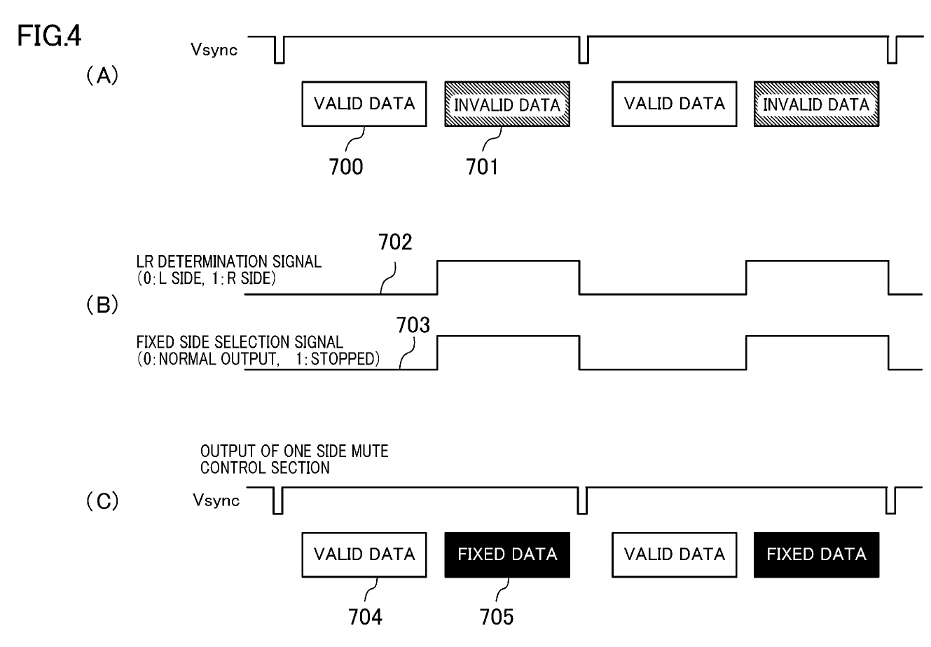

Specifically, the operation will be described in detail with reference to FIGS. 4A-4C. In FIG. 4A, where valid data 700 of a 2D video signal and invalid data 701 are sent to the L side and the R side, respectively, of the 3D transfer format from the video signal source 401, an LR determination signal 702 is 1 when the invalid data on the R side is input as shown in FIG. 4B. In response to this, in the fixed side output section 503 in the one side mute control section 500 of FIG. 2, a fixed side selection signal 703 is 1 when it is the R side. Based on the fixed side selection signal 703, a 2D video signal itself (valid data) 704 is selected by the selector 505 for the L side and fixed data 705 is selected for the R side as shown in FIG. 4C, thereby effectively reducing the power consumption of the power reduction block 412.

### Second Embodiment

Next, a second embodiment of the present invention will be described.

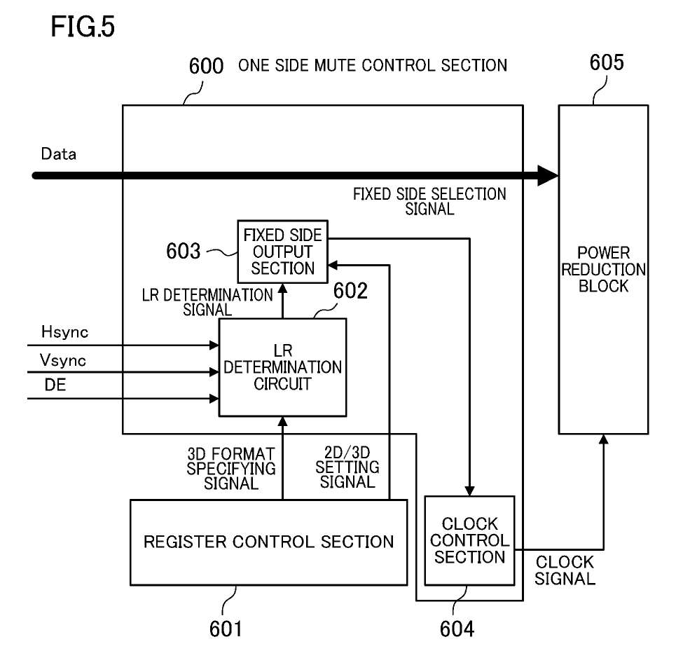

FIG. 5 shows the second embodiment of the present invention, which is a modified version of the one side mute control section 500 shown in FIG. 2.

That is, with the one side mute control section 500 of FIG. 2, the selector 505 is controlled based on the fixed side selection signal from the fixed side output section 503 so that the fixed data 504 is selected and output to the power reduction block 412 on the unused side of the 2D video signal in the 3D transfer format. In contrast, the supply of the clock signal to the power reduction block 412 is stopped, thereby limiting the operation thereof.

Therefore, a one side mute control section 600 of FIG. 5 includes an LR determination circuit 602 for receiving a signal from a register control section 601 and a fixed side output section 603, as in FIG. 2, and also includes a clock control section 604. The clock control section 604 receives a fixed side selection signal from the fixed side output section 603, and stops the supply of the clock signal to a power reduction block 605 when the fixed side selection signal is 1, i.e., on the unused side of the 2D video signal in the 3D transfer format, and resumes the supply of the clock signal to the power reduction block 605 on the used side of the 2D video signal where the fixed side selection signal is 0.

Therefore, also in the present embodiment, the power consumption can be reduced on the unused side of the 2D video signal in the power reduction block 605, as in the first embodiment.

Note that while the power reduction block 605 of the present embodiment includes the power reduction block 412 of FIG. 1, i.e., the input video control section 412a, the color space changing section 412b and the packet loading section 412c, the present invention is not limited to this configuration. For example, it is understood that the color space changing section 412b may be absent, or an image quality-improving circuit, etc., may be provided prior to the color space changing section 412b.

### Third Embodiment

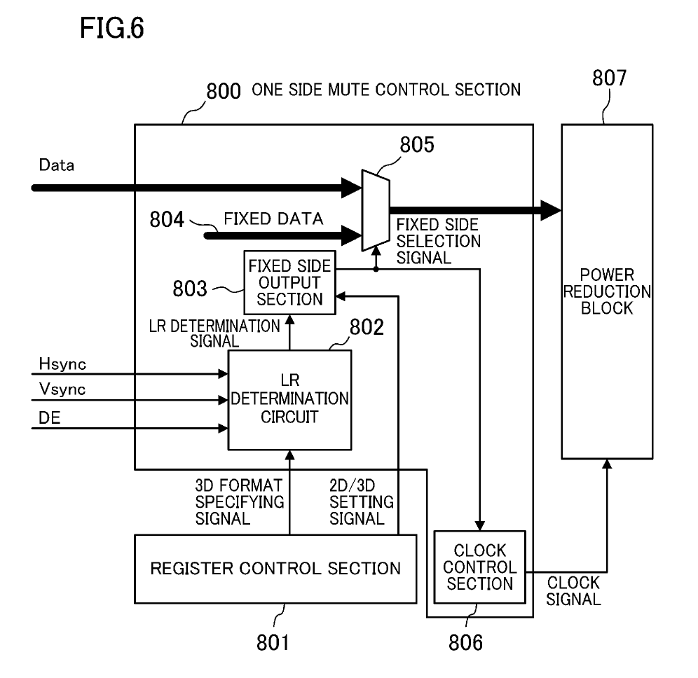

Next, a third embodiment of the present invention will be described with reference to FIG. 6.

The present embodiment is a combination of the first embodiment and the second embodiment.

That is, a one side mute control section 800 shown in FIG. 6 is a combination of the configuration of the one side mute control section 500 of FIG. 2 and that of the one side mute control section 600 of FIG. 5, and specifically includes a clock control section 806, in addition to an LR determination circuit 802, a fixed side output section 803 and a selector 805.

Therefore, in the present embodiment, on the unused side of the 2D video signal in the 3D transfer format, the fixed data 804 is output to a power reduction block 807, and at the same time, the supply of the clock signal to the power reduction block 807 can be stopped by the clock control section 806, thereby reliably preventing the subsequent power reduction block 807 from operating wastefully.

(Variation 1 of One Side Mute Control Section)

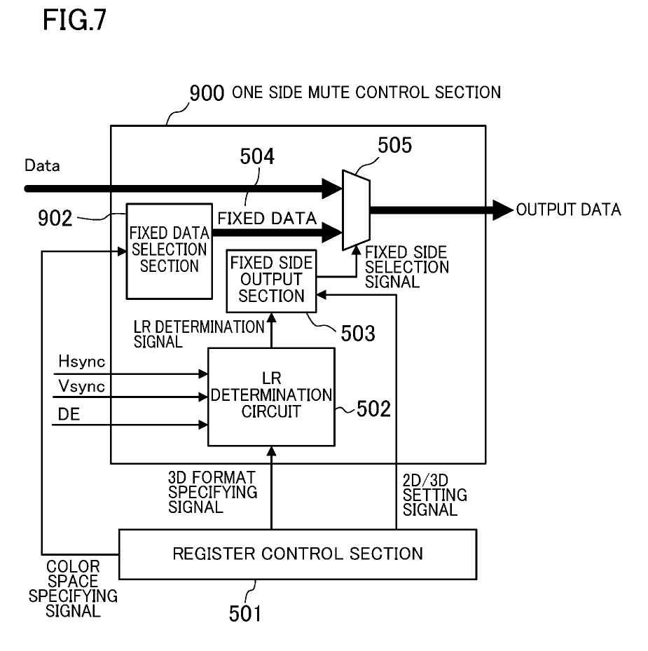

Next, Variation 1 of the one side mute control section will be described with reference to FIG. 7.

A one side mute control section 900 shown in FIG. 7 includes a fixed data selection section 902 in addition to the components of the one side mute control section 500 shown in FIG. 2.

A video signal takes different values for the color black depending on the color space of the input video data. For example, black color data for RGB is R=0×00, G=0×00 and B=0×00. For YCbCr 4:4:4, black color data is Y=0×00 and Cb=Cr=0×80.

In the present embodiment, the color space specifying signal of the input video data is input from a register control section 901 to the fixed data selection section 902, and the fixed data selection section 902 selects the black color data corresponding to the color space specifying signal of the input video data, and outputs the black color data to a selector 903 as the fixed data.

With this configuration, it is possible to output black color data as fixed data by automatically following the changes in the color space of the input video signal, etc.

Note that while black color data is used as fixed data in Variation 1, it is not limited to black and one of various colors may be selected so as to reduce the power consumption by preventing unnecessary operations.

(Variation 2 of One Side Mute Control Section)

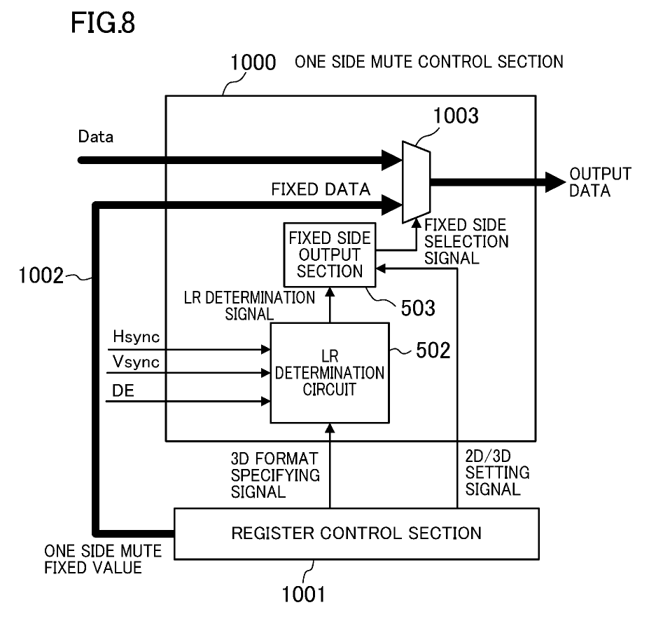

FIG. 8 shows Variation 2 of the one side mute control section.

A one side mute control section 1000 shown in this figure is configured so that the fixed data 1002 to be input to a selector 1003 can be directly set from the host CPU 403 via a register control section 1001.

(Variation 3 of One Side Mute Control Section)

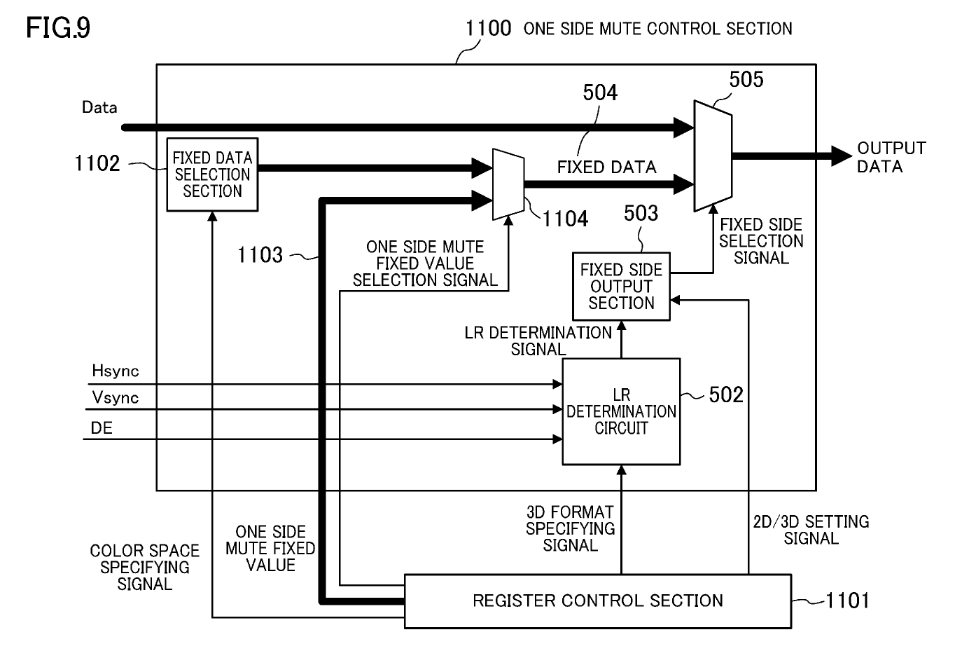

FIG. 9 shows Variation 3 of the one side mute control section.

A one side mute control section 1100 shown in this figure is a combination of the one side mute control section 900 of FIG. 7 and the one side mute control section 1000 of FIG. 8.

That is, the one side mute control section 1100 of FIG. 9 includes a fixed data selection section 1102 for outputting black color data corresponding to the color space specifying signal of the input video data to a selector 1104 as the fixed data, and has a configuration such that fixed data 1103 directly set from the host CPU 403 via the register control section 1001 is output to the selector 1104. Either the fixed data 1103 or the fixed data from the fixed data selection section 1102 is selected by the selector 1104. The selector 1104 selects one of the two fixed data based on the one side MUTE fixed value selection signal output from a register control section 1101.

(Variation 1 of Clock Control Section)

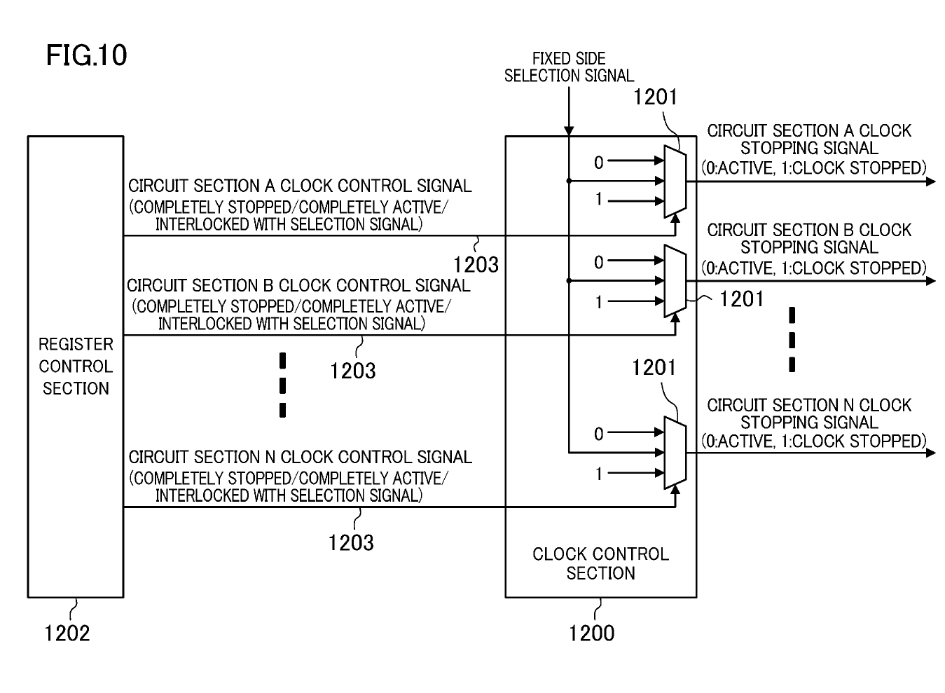

FIG. 10 shows Variation 1 of the clock control section 604 provided in the one side mute control section 600 of FIG. 5.

A clock control section 1200 of FIG. 10 additionally includes a plurality of selectors 1201. The selectors 1201 are controlled by A-N clock control signals (selection signals) 1203 corresponding to circuit sections A-N of the power reduction block 412 sent from a register control section 1202.

For example, in order to stop the supply of the clock signal to the circuit section N in response to the fixed side selection signal, a circuit section N clock control signal 1203 can be selected so that the fixed side selection signal serves as a clock stopping signal, thereby allowing for an operation stopping control based on the fixed side selection signal.

On the other hand, in order to allow the circuit section N to be active continuously irrespective of the fixed side selection signal, the circuit section N clock control signal 1203 can be selected so that 0 is the signal for stopping the supply of the clock signal, thereby outputting 0 irrespective of the fixed side selection signal, and enabling the continuous activation.

Next, in order to allow the circuit section N to be continuously inactive irrespective of the fixed side selection signal, the circuit section N clock control signal 1203 can be selected so that 1 is the signal for stopping the supply of the clock signal, thereby outputting 1 irrespective of the fixed side selection signal, and enabling the continuous inactivation.

As described above, depending on the specifications of each of the circuit sections A-N, one can freely select to stop the supply of the clock signal or select an activation mode.

Note that while the present embodiment is directed to an example where the supply of the clock signal can be completely stopped, completely active or interlocked for each of the circuit sections A-N, the present invention is not particularly limited to this configuration. Particular circuit sections may only be either completely active or interlocked, and any of various configurations may be employed depending on the content of the circuit section to be connected.

(Variation 2 of Clock Control Section)

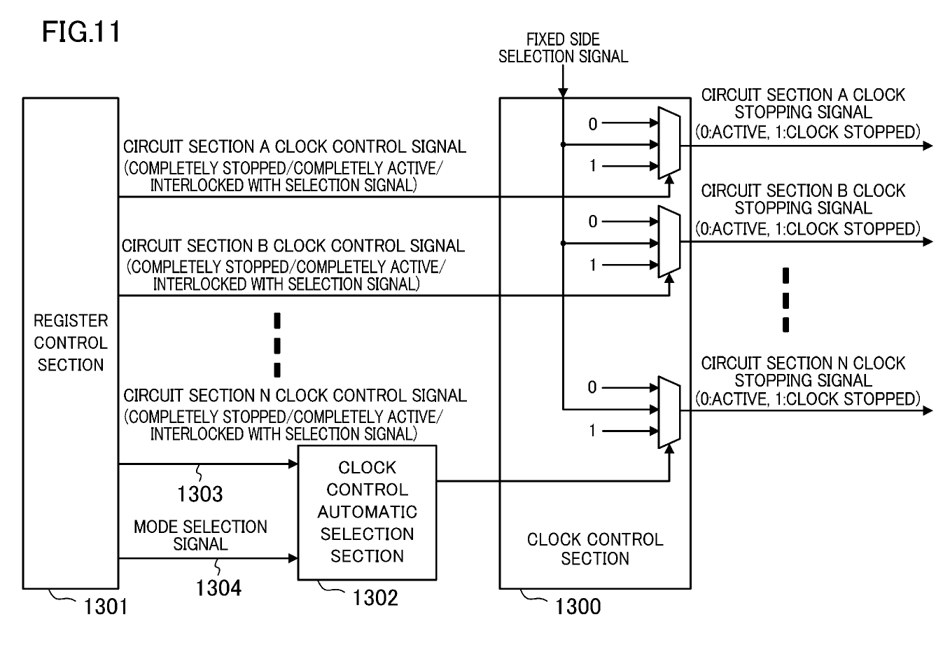

FIG. 11 shows Variation 2 of the clock control section.

A clock control section 1300 shown in this figure includes a clock control automatic selection section 1302 added between the clock control section 1300 and a register control section 1301. The clock control automatic selection section 1302 receives a circuit section N clock control signal 1303 and a mode setting signal 1304 from the register control section 1301.

Now, for example, consider a case where the mode setting signal 1304 is the input/output space information, and the circuit section for which the supply of the clock signal is controlled is the color space changing section.

If the input/output color space change has been set, when a 2D video signal (valid data) is input, a color space change is needed and the clock signal is supplied to the color space changing section, whereas when invalid data on one side that is unused is input, the supply of the clock signal can be stopped. On the other hand, if the input/output color space change has not been set, the color space changing section does not need to supply the clock signal whether valid data is input or invalid data is input.

Therefore, if information indicating no input/output color space change is sent from the mode setting signal 1304, the clock control automatic selection section 1302 determines that it is not necessary to supply the clock signal and sends the clock control section 1300 a signal instructing to completely stop the supply of the clock signal, thus completely stopping the supply of the clock signal only for the color space changing section.

Thus, depending on the various operation modes, it is possible to individually use different control methods for circuit sections that need to be operated and circuit sections that do not need to be operated, and it is also possible to automatically determine whether to automatically completely stop the operation or stop the operation depending on the fixed side selection signal for each operation mode.

Note that while the present embodiment is directed to an example where only one clock control automatic selection section 1302 is provided, the present invention is not limited thereto, and it may be provided for all circuit sections or provided only for some circuit sections for which it is effective.

(Variation 1 of LR Determination Circuit)

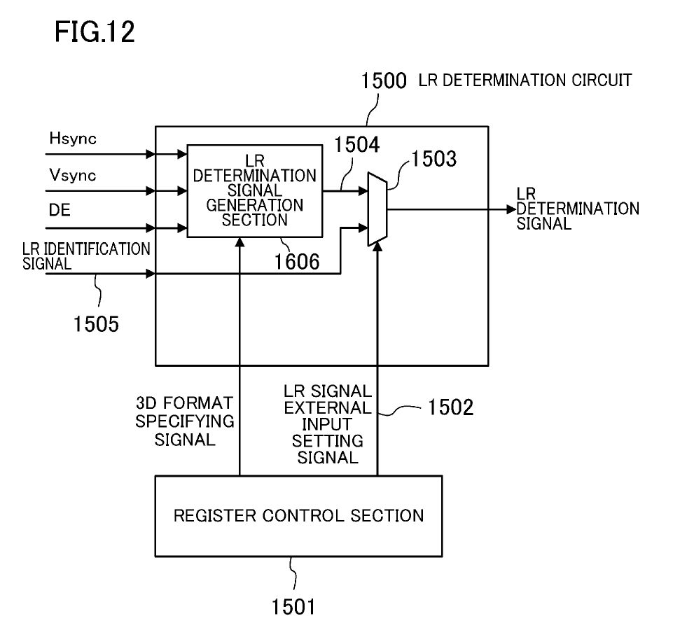

FIG. 12 shows Variation 1 of the LR determination circuit.

In an LR determination circuit 1500 shown in the figure, an LR signal external input setting signal 1502 is input to a selector 1503 from a register control section 1501. Based on the LR signal external input setting signal 1502, the selector 1503 selects either an LR determination signal 1504 generated inside an LR determination signal generation section 1606 or an LR identification signal (identification signal) 1505 input from outside.

Thus, in the present embodiment, since the operation of selecting the selector 1503 can be controlled by the setting from the host CPU 403, if the external LR identification signal 1505 is input, the LR identification signal 1505 can be selected by the selector 1503 to be used as the LR determination signal.

Note that in the present embodiment, the LR determination signal external input setting signal 1502 is output from the register control section 1501, and the setting signal 1502 is used as the selection control signal of the selector 1503. However, if such a format is assigned that an LR determination signal comes from outside as the 3D format specifying signal, it is possible to determine whether the LR determination signal is an external input based on the 3D format specifying signal, and to allow the selector 1503 to select based on the determination signal.

(Variation 1 of Fixed Side Output Section)

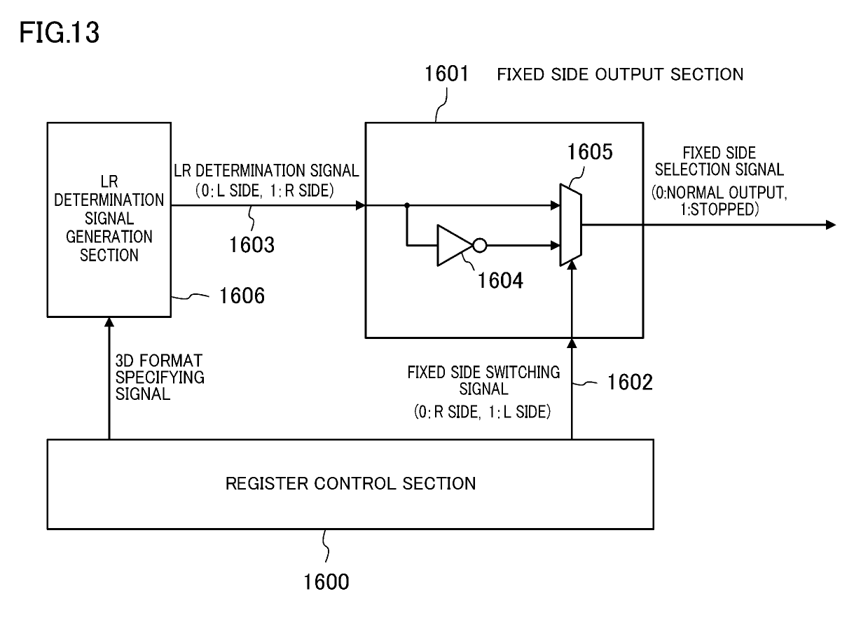

FIG. 13 shows Variation 1 of the fixed side output section.

In a fixed side output section 1601 shown in this figure, a fixed side switching signal 1602 is input to the fixed side output section 1601 from a register control section 1600, and the selection control of a selector 1605 is performed based on the fixed side switching signal 1602. The fixed side switching signal 1602 is set by the host CPU such that 0 means it is fixed to the R side and 1 means it is fixed to the L side.

The selector 1605 includes an input through which an LR determination signal 1603 from the LR determination signal generation section 1606 is received as it is, and another input through which the LR determination signal 1603 is received after being inverted by an inverter 1604, and the selector 1605 selects the signal which has been inverted by the inverter 1604 when the fixed side switching signal 1602 is 1.

With this configuration, when the fixed side switching signal 1602 is 0, the LR determination signal 1603 is output, as it is, as the fixed side selection signal, and the selector 1605 outputs the fixed side selection signal which is 1 when the R side is input, thereby fixing the R side to the fixed data.

In contrast, when the fixed side switching signal 1602 is 0, the inverted signal of the LR determination signal 1603 is selected by the selector 1605 and output as the fixed side selection signal, and the fixed side selection signal which is 1 is output on the L side, thereby fixing the L side to the fixed data.

Therefore, in this variation, it is possible to freely set, from the host CPU 403, whether the R side is set to the fixed data or the L side is set to the fixed data.

(Variation 2 of Fixed Side Output Section)

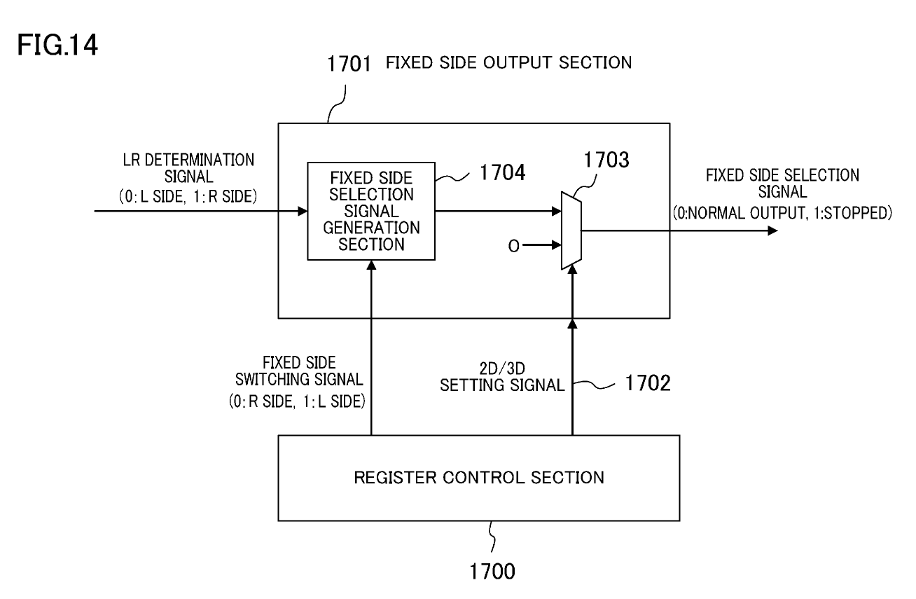

FIG. 14 shows Variation 2 of the fixed side output section.

A fixed side output section 1701 shown in this figure receives a 2D setting signal or 3D setting signal 1702 from a register control section 1700, and the 2D/3D setting signal is used as the control signal for a selector 1703. If the host CPU 403 has made a 3D transfer setting for the register control section 1700, the selector 1703 outputs 0 based on the 3D setting signal 1702 to constantly fix the fixed side selection signal to 0, and therefore the one side MUTE control is not performed.

On the other hand, if the host CPU 403 has made a 2D transfer setting, the selector 1703 selects a fixed side selection signal from a fixed side selection signal generation section 1704.

Thus, the host CPU 403 gives a notification as to whether the mode is a 3D transfer mode or a 2D transfer mode, and the one side MUTE function is enabled in the 2D transfer mode whereas the one side MUTE function is reliably stopped in the 3D transfer mode, thereby ensuring the transfer of the 3D video signal.

(Variation 3 of Fixed Side Output Section)

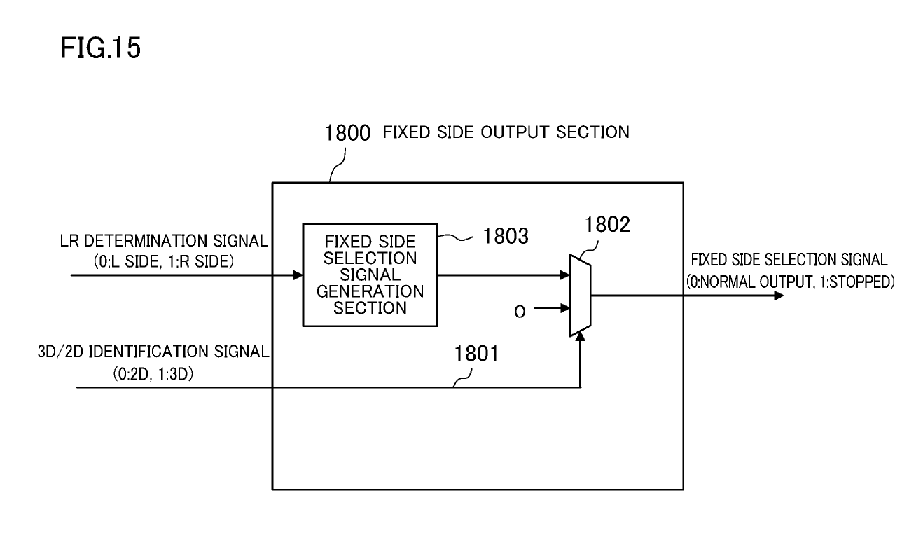

FIG. 15 shows Variation 3 of the fixed side output section.

In the fixed side output section 1701 of FIG. 14, the selector 1703 is controlled based on the 2D/3D setting signal from the host CPU 403 via the register control section 1700, whereas in a fixed side output section 1800 of FIG. 15, a 3D/2D identification signal 1801 input from outside is used as the selection control signal for a selector 1802.

Therefore, also in this variation, the fixed side selection signal of a fixed side selection signal generation section 1803 is selected by the selector 1802 so as to enable the one side MUTE function when the external 3D/2D identification signal 1801 indicates a 2D transfer mode, whereas 0 is used as the fixed side selection signal in a 3D transfer mode, thereby stopping the one side MUTE function and ensuring the transfer of the 3D video signal.

(Variation 4 of Fixed Side Output Section)

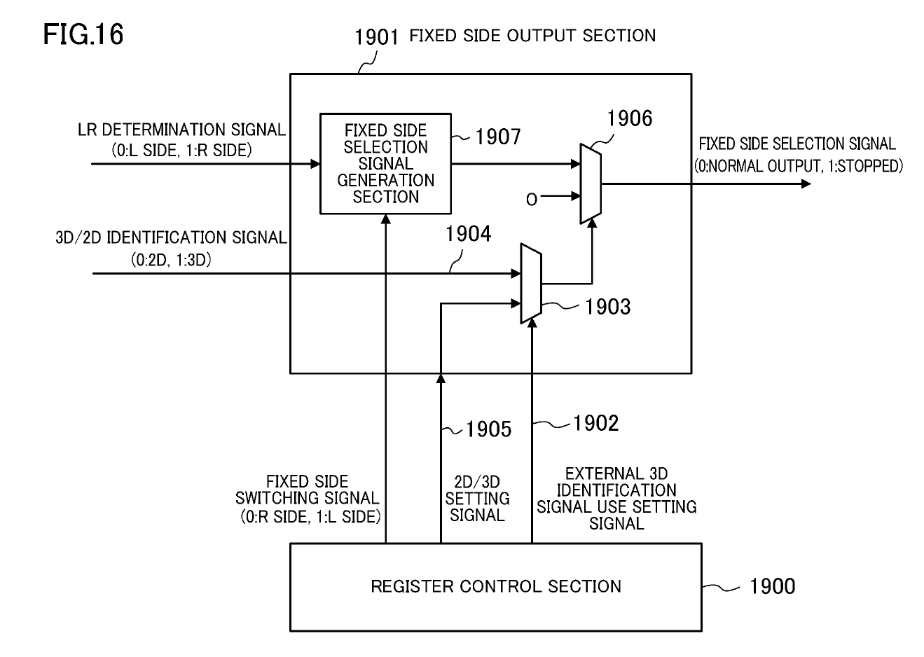

FIG. 16 shows Variation 4 of the fixed side output section.

A fixed side output section 1901 shown in this figure is a combination of the fixed side output sections 1701 and 1800 of FIGS. 14 and 15, and includes both the 2D/3D selection setting from the host CPU 403 and the input of the 2D/3D identification signal from outside.

Specifically, in addition to a fixed side selection signal generation section 1907 and a selector 1906, it further includes another selector 1903, and the selector 1903 receives a 2D/3D setting signal 1905 from a register control section 1900 and a 3D/2D identification signal 1904 from outside, with an external 3D identification signal use setting signal 1902 from the register control section 1900 used as a switching control signal for the selector 1903.

If the host CPU 403 sets the external 3D identification signal use setting signal 1902 to the external 3D/2D identification signal side, the external 3D/2D identification signal 1904 is the selection control signal for the selector 1906. Based on the selection control signal, the selector 1906 switches between the fixed side selection signal from the fixed side selection signal generation section 1907 and 0.

On the other hand, if the host CPU 403 sets the external 3D identification signal use setting signal 1902 to the host CPU side, the 2D setting signal or 3D setting signal 1905 from the register control section 1900 is the control signal for the selector 1906.

As described above, the host CPU 403 can freely select whether the fixed side selection signal is controlled using the external 3D/2D identification signal 1904 or the 2D/3D selection is made by the host CPU 403.

As described above, even if a 2D video signal is transferred in a 3D transfer format, it is possible to reduce the power consumption by preventing unnecessary operations of signal processing circuits in the video signal processing device. Thus, the present invention is useful as a built-in device such as a blu-ray or DVD player.

What is claimed is:

1. A video signal processing device for processing a 3D video signal, comprising:
a signal processing section for receiving the 3D video signal and performing a predetermined signal process; and
a one side mute control section, wherein when a 2D video signal is transmitted in a 3D video transfer format where left-eye data is loaded on an L side and right-eye data is loaded on an R side with the 2D video signal using one of the two sides, the one side mute control section determines whether the 2D video signal is on the L side or on the R side so as to stop an operation of the signal processing section during a period of the one side that is not used by the 2D video signal.

2. The video signal processing device of claim 1, wherein
the signal processing section performs a predetermined signal process on a video signal received in an HDMI standard.

3. The video signal processing device of claim 1, wherein
the one side mute control section stops the operation of the signal processing section by outputting fixed data to the signal processing section during the period of the one side that is not used by the 2D video signal.

4. The video signal processing device of claim 1, wherein
the one side mute control section stops the operation of the signal processing section by stopping supply of a clock signal to the signal processing section during the period of the one side that is not used by the 2D video signal.

5. The video signal processing device of claim 1, wherein
the one side mute control section stops the operation of the signal processing section by stopping supply of a clock signal to the signal processing section while outputting fixed data to the signal processing section during a period of the one side that is not used by the 2D video signal.

6. The video signal processing device of claim 1, wherein
the one side mute control section receives a color space specifying signal of the input 2D video signal and outputs black color data corresponding to the color space specifying signal to the signal processing section as the fixed data.

7. The video signal processing device of claim 1, wherein
the one side mute control section receives the fixed data from a host CPU and outputs the received fixed data to the signal processing section.

8. The video signal processing device of claim 1, wherein the one side mute control section has two functions including:
a function of receiving a color space specifying signal of the input 2D video signal and outputting black color data corresponding to the color space specifying signal to the signal processing section as the fixed data; and
a function of receiving the fixed data from a host CPU and outputting the received fixed data to the signal processing section.

9. The video signal processing device of claim 4, wherein
a plurality of signal processing sections are provided each for performing a predetermined signal process,
the one side mute control section
receives from outside a selection signal for selecting one of the plurality of signal processing sections, and
stops supply of a clock signal to one of the signal processing sections selected by the selection signal during a period of the one side that is not used by the 2D video signal.

10. The video signal processing device of claim 9, wherein
the one side mute control section receives an operation mode setting signal and determines based on the received mode setting signal whether supply of a clock signal is stopped during a period of the one side that is not used by the 2D video signal or the supply of the clock signal is stopped also on the side that is used.

11. The video signal processing device of claim 1, wherein
the 3D transfer format is set from outside to the one side mute control section, and the determination between the L side and the R side is made in accordance with the set 3D transfer format.

12. The video signal processing device of claim 1, wherein
the one side mute control section receives from outside an identification signal indicating an identification of the L side and the R side of the 3D transfer format, and the determination between the L side and the R side is made based on the received identification signal.

13. The video signal processing device of claim 11, wherein
the one side mute control section receives from a host CPU a switching signal indicating whether the L side or the R side, for which the determination has been made, is regarded as one side that is not used by the 2D video signal, and stops the operation of the signal processing section during a period of the one side that is not used by the 2D video signal based on the received switching signal.

14. The video signal processing device of claim 1, wherein
a 2D/3D setting signal indicating whether a currently-input video signal is a 2D video signal or a 3D video signal is received from a host CPU, and the operation of the signal processing section is stopped during a period of the one side that is not used by the 2D video signal based on the received 2D/3D setting signal.

15. The video signal processing device of claim 1, wherein
a 2D/3D setting signal indicating whether a currently-input video signal is a 2D video signal or a 3D video signal is received from outside, and the operation of the signal processing section is stopped during a period of the one side that is not used by the 2D video signal based on the received 2D/3D setting signal.

16. The video signal processing device of claim 1, wherein
2D/3D setting signals each indicating whether a currently-input video signal is a 2D video signal or a 3D video signal are received from a host CPU and from outside, and the operation of the signal processing section is stopped during a period of the one side that is not used by the 2D video signal based on the received 2D/3D setting signals.

17. A video processing system comprising the video signal processing device of claim 1.

18. A semiconductor integrated circuit comprising the video signal processing device of claim 1.

19. The video signal processing device of claim 2, wherein
the signal processing section includes a process circuit section for performing a predetermined process on a video signal, and a packet loading section.

20. The video signal processing device of claim 19, wherein
the process circuit section includes an input video control section, and a color space changing section.

21. A video signal processing method for processing a 3D video signal, comprising:
receiving a 2D video signal transmitted in a 3D video transfer format where left-eye data is loaded on an L side and right-eye data is loaded on an R side with the 2D video signal using one of the two sides,
then determining whether the received 2D video signal is on the L side or on the R side, and
stopping an operation of a signal processing section, which is for receiving the 3D video signal and performing a predetermined signal process, during a period of the one side that is not used by the 2D video signal based on the determination result.
